(19) United States
(12) Patent Application Publication
(10) Pub. No.: US 2014/0061421 A1
(43) Pub. Date: Mar. 6, 2014

(54) IV ORGANIZER AND LOCKING DEVICE

(71) Applicant: Daniel G. J. Lane, Salisbury, MD (US)

(72) Inventor: Daniel G. J. Lane, Salisbury, MD (US)

(21) Appl. No.: 13/598,545

(22) Filed: Aug. 29, 2012

(51) Int. Cl. F16L 3/22; F16L 3/10

(52) U.S. Cl. 248/542

(57) ABSTRACT

A device according to various embodiments can include a durable IV organizer and cover locking device for identifying, aligning and securing multiple IV lines, catheters or fluid-like lines therein to prevent damage, deformation and entanglement thereto. Some embodiments can include a cover provided with a plurality of recessed channels on an under surface. A support base is provided with the plurality of recessed channels on a top surface for retaining a plurality of cables. A hinge is interdisposed between the cover and the support base to enable the cover and the support base to move between a closed position and an open position. A latching mechanism is configured to latch the cover and the support base in the closed position. At least one pair of retaining clips is disposed along the elongated channels of the support base to retain each one of the plurality of cables.

### FIELD OF THE INVENTION

The present invention relates generally to a portable IV organizer and cover locking device for aligning, retaining and clearly identifying a plurality of IV lines in an organized manner to protect and prevent the IV lines from entanglement with one another and/or with other types of lines or wiring and damage thereto. The IV organizer and cover locking device is easily attachable, removable and transportable between desired support surfaces or locations.

### INTRODUCTION

The subject matter of this invention is directed primarily to flexible lines in the form of fluid conduits that are commonly used in the medical profession. It is common medical practice to treat and medicate a patient by introducing therapeutic agents, drugs, medications, nutrients and various other liquids to a patient through intravenous (IV) fluid conduit systems. Many of the prior IV fluid systems disclose article or fluid line organizers and holder assemblies having a plurality of independent article or fluid line support sections therein to independently receive a respective article or fluid line therein for receiving, enclosing and holding the same against axial and lateral movement. Such article or fluid line organizers and holder assemblies having connector means for releasable attachment to a patient's garment or skin or other body parts with adhesive means, and adhesively attached to surgical drapes and bed sheets. Note that various other types of alternative securing means have been utilized.

It is well known, that the presence of numerous IV lines, catheters or the like can result in situations where health care professionals will inadvertently overlook the specific contents of each IV line, unless reference is made to the identification of the corresponding reservoirs. Therefore, extreme care must be exercised to always ensure that the right medication is injected into the right IV line, catheter or the like. This can result in a matter of life or death for a patient. Also, when a plurality of IV lines, catheters or the like physically interfere with one another, such may cause any IV lines, catheters or the like to become disconnected, which can be extremely detrimental to the well-being of a patient. This increases the risk of the wrong medication or blood going to a patient, not enough or no medication reaching a patient and patient injury.

Further, the entanglement of IV lines, catheters or the like is a common problem in hospitals, clinics, doctor offices, nursing facilities or the like. Many times this is caused by patients moving about, as well as, the health care professionals not being cognizant of the proper connection and placement of the IV lines, catheters or the like in a non-crossing or overlapping relationship.

Therefore, there is a dire need within hospitals, clinics, doctor offices, nursing facilities or the like to have a compact and lightweight, economical to manufacture, easy to attach, remove and transport between locations and maintenance tree IV organizer and cover locking device to prevent multiple IV lines, catheters or the like from becoming entangled and maintaining them separate and properly making identification apparent to any health care professional that is attending a patient.

The above mentioned prior art IV organizer and cover locking devices, take on many different designs and structures disclosed and described in the following U.S. Pat. Nos. 4,397,647, 4,795,429, 4,971,271, 5,085,384, 5,224,674, 5,226,892, 5,389,082 and 6,458,104, to name just a few.

It is apparent that many of the prior art IV organizer and cover locking devices were designed and constructed to curtail manufacturing costs and time. Many attempted to economically fabricate by utilizing standard shapes and sizes of existing materials, eliminating the need for expensive machining or molding of materials, and eliminating complex installation procedures. However, these prior art IV organizer and cover locking devices still lack a cost effective way of mass producing, assembling and installation in a simple and cheap way in order to be economically attractive.

However, the disclosed invention is designed and constructed to provide a cost effective way of mass producing, assembling and installing in a simple and cheap way in order to be economically attractive and overcome the above cost and time issues. This will attract and allow more people, hospitals, clinics, doctor offices, nursing facilities or the like throughout the United Sates and the World to utilize the disclosed invention.

### SUMMARY OF THE INVENTION

The present invention is designed and constructed to provide a very simple process to manufacture relatively inexpensive and durable IV organizer and cover locking devices as one-piece units fabricated from a simple plastic molding process with a minimum use of required machinery and tools. Such low cost and easy method of fabricating materially contributes to a unique IV organizer and cover locking device that is more efficient and easy to use and operate by anyone, especially those in the healthcare profession.

According to one aspect of the present invention an IV organizer and cover locking device embodying this invention comprises a plastic molded cover section, support base section and an integral hinge section disposed between the cover and support base sections. Each of the cover and support sections has a plurality of elongated recessed channels disposed therein along an entire length thereof forming a one-piece unit. The one-piece unit further includes an integral molded snap-action latching member disposed along an edge portion of each of the cover and support sections. Note that the snap-action latching members could be disposed along an inside face portion of the each of the cover and support base sections, if desired.

Note that the snap-action latching members can take on different types of snap-action latching members, such as an integral tab or rib on one of the sections and a recess or hole on the other section to cooperate with one another, an integral C-shaped or a U-shaped latching member extending from one of the sections and an integral projecting tongue member extending from the other section to be received within the C-shaped or U-shaped latching member or an integral first extended projection on one of the sections and a second integral mating extended projection that that is adapted to cooperatively engage with one another in a tight friction or wedge type fit. Preferably, the latching member of the present invention includes a C-shaped or a U-shaped latching member extending from a end portion of the cover section opposite the hinged end and a projecting tongue member extending from the support base section to be received within the C-shaped or U-shaped locking member as the C-shaped or the U-shaped latching member is flexed over the projecting tongue member. Note that the snap-action latching can be substituted by various other mechanical types of latching or locking means that would be obvious to one of ordinary skill in the art, at the time the invention was made, if desired.

According to another aspect of the present invention, the upper portion of the cover section has at least one color-coded indicia or marking disposed above and in alignment with the plurality of elongated recessed channels of the cover section disposed on an under surface thereof. The color-coded indicia or marking includes a frictional-fit color-coded marker member that is to be received in a shallow identification opening above and in alignment with the plurality of elongated recessed channels. Note that the color-coded indicia or marking can take on various types of structural shapes and designs that are obvious to one of ordinary skill in the art, at the time the invention was made. Note that the shallow opening can be of any desired size, length and shape. Such shallow opening could extend substantially the entire length of the elongated recesses. Preferably, the shallow opening extends a specified distance above and in alignment with the plurality of elongated recessed channels so that multiple marker openings can be positioned thereon to receive multiple color-coded marker members. Also, the shallow opening has a certain depth that does penetrate into the plurality of elongated recessed channels due to the specified thickness of the cover section.

The marker members include an upper flat elongated portion with a triangle-shaped wedge or tapered portion extending there from to allow the marker members to be frictionally-fitted into the shallow marker openings. This allows the markers to be easily moved from one location to another so that multiple IV lines, catheters or other types of fluid-like lines can be easily moved about and changed from one elongated recessed channel to another, if desired. This easy changeability could be a direct result of moving medical fluid sources around, so that the multiple IV lines, catheters or the fluid-like lines are never entangled or overlapped with one another. Also, this changeability could be a direct result of the length of the multiple IV lines, catheters or the fluid-like lines in relationship to a patient and/or the medical fluid sources. Another reason for changeability could be a direct result of changing the color codes that represents the multiple IV lines, catheters or the fluid-like lines within the multiple elongated recessed channels.

In a further aspect of the present invention, the support base section of the durable IV organizer and cover locking device includes at least a pair of upstanding flexible and rigid retaining clips. Each clip is spaced substantially equidistantly along opposing side edges of the plurality of elongated recessed channels. The opposing pairs of retaining clips include left upward extending arm member and a right upward extending arm member that provide a substantial U-shaped securing passage for retaining multiple IV lines, catheters or the fluid-like lines within the multiple elongated recessed channels. The upper ends of the left upward extending arm member and the right upward extending arm member define an opening that is slightly smaller than the diameter of multiple IV lines, catheters or the fluid-like lines, so that when the multiple IV lines, catheters or the fluid-like lines are pressed through the smaller opening so that the multiple IV lines, catheters or the fluid-like lines are able to be retained within the flexible and rigid retaining clips without deformation thereto.

Each of the upper ends of the left and right upward extending arm members include an outwardly slanted extension that forms a slide-like ramp member that creates a larger portion of the opening that allows the multiple IV lines, catheters or the fluid-like lines to slide easily along the slide-like ramp member into the opening and into the plurality of elongated recessed channels. This sliding action allows the multiple IV lines, catheters or the fluid-like lines to easily expand the left and right arm member members further outward to increase the opening to a wider position to permit the fluid lines to be easily inserted there through into the plurality of elongated recessed channels without deformation thereto. The retention of the multiple IV lines, catheters or the fluid-like lines within the plurality of elongated recessed channels occurs when the left and right arm members retract back inward to decrease the opening to a diameter that is smaller than the multiple IV lines, catheters or the fluid-like lines.

Even though a pair of upstanding flexible and rigid retaining clips have been recited above, it is obvious to one of ordinary skill in the art, at the time invention was made, to utilize any number of retaining clips along the multiple elongated recessed channels, if desired.

Also, the elongated recessed channels can be designed to have different diameters to accommodate different size IV lines, catheters or the like.

The materials used in the construction of all components of the durable IV organizer and cover locking device are preferably polymeric, resinous and the like. Although, different types of plastic material may be used in order to accomplish the desired construction of the di able IV organizer and cover locking device. It is envisioned that the durable IV organizer and cover locking device will be formed by injection molding, although other methods of forming the durable IV organizer and cover locking device known in the prior art are contemplated as well. Additionally, the durable IV organizer and cover locking device of the present invention may be easily cleaned, sterilized or sanitized and reused, if desired.

Furthermore, the bottom surface of the support base section of the durable IV organizer and cover locking device has securing means in the form of a hook-and-loop like fabric or Velcro material. This hook-and-loop like fabric or Velcro material will matingly attach to a complimentary hook-and-loop like fabric or Velcro material on the surface that it will be attached to. Also, the securing means could be a double-side adhesive or durable tape means or various types of mechanical attaching means, if desired. It would also be obvious to one of ordinary skill in the art to place the securing means solely on the bottom surfaces of the plurality of the elongated recessed channels, if desired.

Lastly, it is imperative to note that the durable IV organizer and cover locking device can be utilized in various other types of environments, such as, telecommunication cables, computer wiring, electrical wiring, and other fluid conduits and wiring environments to prevent entanglement, which will work very effectively in the same manner as the present invention.

These and other features, aspects and advantages of the present will become better understood with regard to the following description, appended claims and accompanying drawings.

### BRIEF DESCRIPTION OF THE DRAWINGS

The present invention may be better understood, along with its numerous Objects, features, and advantages made apparent to those skilled in the art by referencing the accompanying drawings.

FIG. 1 illustrates a top view of a durable IV organizer and cover locking device in a fully open position according to the present invention;

FIG. 2 illustrates a perspective view of a durable IV organizer and cover locking device in a closed position according to the present invention;

FIG. 3 is another exemplary embodiment of a durable IV organizer and cover locking device according to the present invention;

FIG. 4 illustrates a perspective view of another exemplary embodiment of a durable IV organizer and cover locking device in a fully closed position according to the present invention;

FIG. 5 illustrates a top view of the durable IV organizer and cover locking device in a fully open position according to the present invention;

FIG. 6 illustrates a fully closed top view of the durable IV organizer and cover locking device with identification markers according to the present invention;

FIG. 7 illustrates an isometric cut-out-sectional view of the durable IV organizer and cover locking device with identification marker openings to receive the identification markers and an exploded view of the latching means according to the present invention;

FIG. 8 illustrates an isometric view of a particular identification marker of the durable IV organizer and cover locking device according to the present invention;

FIG. 9 illustrates a cutaway side view of the support base section with integral flexible and rigid retaining clips and attachment means located on a bottom surface of the durable IV organizer and cover locking device according to the present invention;

FIG. 10 is a perspective view showing the application of the color-coded sleeve and the IV organizer releasably attached to a plurality of IV tubes connected to a plurality of drip bags;

FIG. 11 is a side view of an exemplary embodiment of a color-coded sleeve in a retracted position within the IV organizer before insertion of the fluid tubing in accordance with the present invention;

FIG. 12 is a side view of the color-coded sleeve slightly extended from the IV organizer:

FIG. 13 is a side view of the color-coded sleeve in FIG. 9 extended further outward from the IV organizer;

FIG. 14 is a side view of the IV organizer to illustrate the connecting of one color-coded sleeve to one IV bag.

FIG. 15 illustrates the flexible material made in connection with the tubing of color-coded sleeve during manufacturing; and

FIG. 16 is a sectional view taken along line A-A in FIG. 13 of the color-coded sleeve with the fluid tubing inserted therein.

### DETAILED DESCRIPTION

Reference will now be made in detail to the preferred embodiments of the invention, examples of which are illustrated in the accompanying drawings. While the invention will be described in conjunction with the accompanying drawings, it will be understood that they are not intended to it the invention to the accompanying drawings. On the contrary, the present invention is intended to cover alternatives, modifications and equivalents, which may be included within the spirit and scope of the invention as defined by the appended claims.

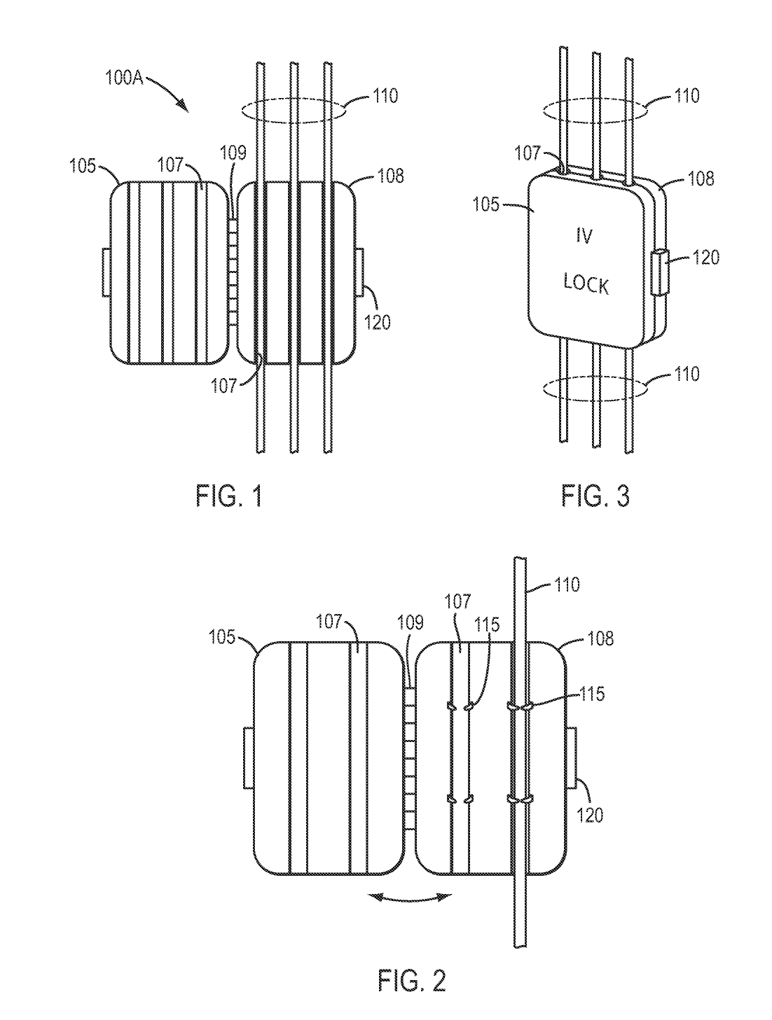

FIG. 1 illustrates a general concept of a durable IV organizer and cover locking device 100A according to the present teaching. FIG. 1 shows a top view of the device 100A in a fully open position. The device 100A includes a cover section 105, a base section 108, and a hinge section 109, which joins together the cover section 105 and the base section 108. The base section 108 includes a plurality of recessed channels 107 disposed therein for receiving multiple IVs, catheters, and the like shown by elements 110. The cover section 105 similarly includes a plurality of recessed channels 107, which are complementary in shape and size to the plurality of recessed channels 107 provided within the base section 108 such that they surround and securely retain the fluid lines 110 within the device 100A when the device is in a fully closed position as shown in FIG. 3. A latching mechanism 120 is provided to latch the device in the fully closed position. Similar to FIG. 1, FIG. 2 illustrates a durable IV organizer and cover locking device that includes the addition of at least a pair of retaining clips 115 for assisting with retaining the fluid lines 110 within the plurality of recessed channels 107. Each retaining clip 115 is spaced approximately equidistantly along opposing side edges of the plurality of elongated recessed channels 107. The retaining clips 115 retain the fluid lines 110 by slightly grasping them without deforming the lines to enable the fluid to freely flow through. The retaining clips 115 enable a variety of fluid lines having various configurations such as size, shape, thickness, etc. to be securely retained within the recessed channels 107.

It should be understood that the devices shown and described herein with reference to the figures are nonlimiting and exemplary only. Those skilled in the art would understand that various sizes, shapes and configurations may be envisioned for the device without departing from the scope of the present teachings. For example, the device may be configured having a configuration such as circular, square, rectangular, triangular, oval, etc. In various embodiments, the device may be in the form of a consumable product, configured to be disposed after use, or may be in the form of a reusable product. Multiple units of the device may be manufactured having various configurations to accommodate fluid lines having different lengths and sizes. During use, the user may be provided with a selection of the various multiple units and the user then selects the device most appropriate for the use. The device can be manufactured having multiple numbers of channels (e.g., 2, 3, 5 or 7) to accommodate any number of fluid lines. In some embodiments, the device may be configured as a standard model having two or three channels to accommodate standard IV fluid lines. Other embodiments of the device may be configured to receive fluid lines having various thicknesses. For example, some embodiments may be designed to accommodate various fluid line thicknesses within a single device. Various materials can be used to form a piece of or the entire device such as polymers, metals, ceramics, powdered metals, thermal plastic composites, etc. Combinations of these or other materials also may be used to manufacture a device according to the invention.

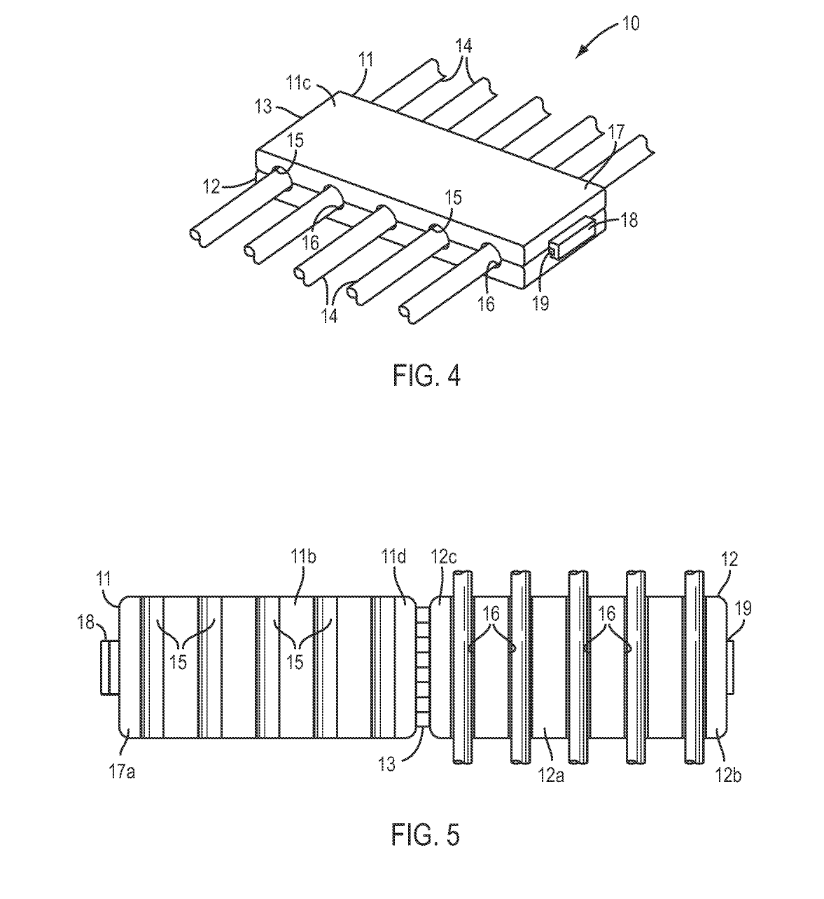

FIG. 4 of the present invention shows a perspective view of a durable IV organizer and cover locking device 10 in a fully closed position comprising an integral upper cover section member 11 with a flat smooth top surface 11a, a lower support base member 12 and a rear surface 11c having a peripheral edge defining an integral hinge section 13, all preferably made from polymeric, resinous and the like material. It is hereby acknowledged that the metal plates 11 and 13 can be made out of various other types of metals, if desired. The upper cover section member 11, the lower support base member 12 and the integral hinge section 13 forms a one-piece unitary device. As shown in FIG. 4, a plurality of recessed channels 15 on an undersurface thereof that extends along an entire length of the upper cover section member 11. The plurality of recessed channels 15 take on a form that is arcuate in shape or that has a semi-circular configuration that would accommodate circular-like IVs, catheters, and other fluid conduits therein as represented by elements 14 for supplying medicines, blood and the like to a patient.

In addition, the cover section member 11 has a front surface 17 with a flexible and rigid latching member 18 extending from a peripheral edge thereof. The support base section member 12a flexible and rigid latching member 19 extending from a peripheral edge thereof. This allows the latching member 18 to be flexed so that it will pass over the latching member 19 to cooperatively engage one another in a locking relationship. This latching feature will be discussed in greater details later.

FIG. 5 is a top view that shows the durable IV organizer and cover locking device 10 in a fully open position. This vie shows the cover section 11 with an undersurface 11b with a plurality of the recessed channels 15 disposed therein for receiving multiple Ws, catheters, and the like as shown by elements 14 supported within the plurality of recessed channels 16 disposed within a top surface 12a of the support base section 12. The undersurface 11b includes a front undersurface 17a defining a peripheral edge that has the latching member 18 extending there from. As further illustrated in FIG. 5, the top surface 12a has a front surface 12b that includes a front undersurface 12b defining a peripheral edge that has the latching member 19 extending there from. Note that the rear top surface 11c and the rear undersurface 11d of the cover section 11 and the top rear surface 12c and the rear undersurface 12c of the support base section 12 defines the peripheral edge that forms the hinge section 13 that joins the cover section 11 and the support base section 12 together as a single one-piece unit.

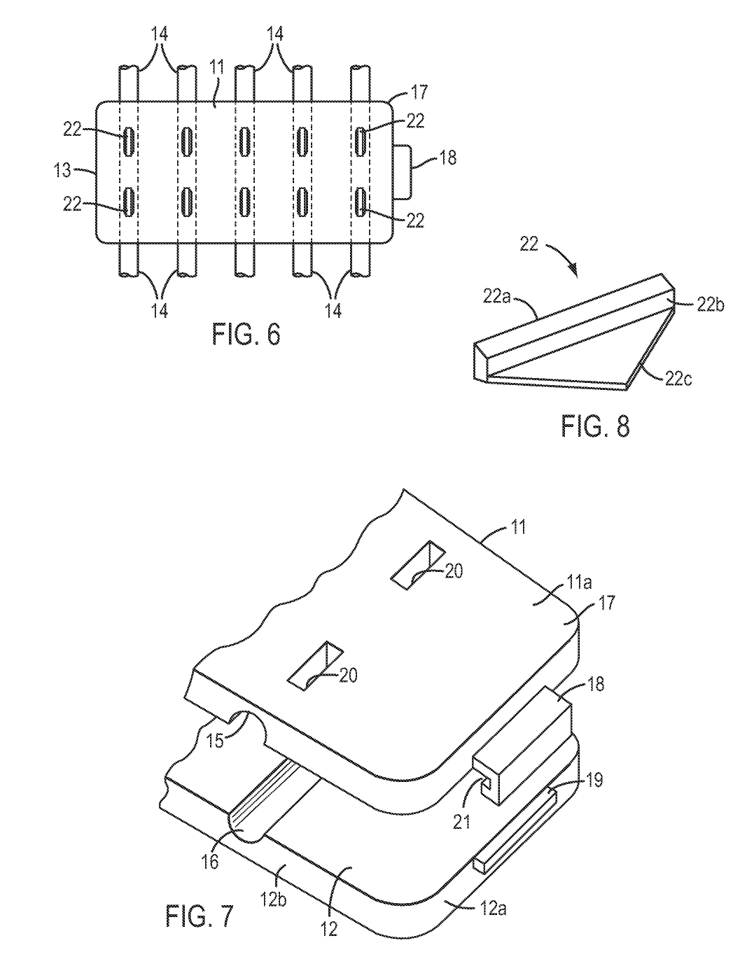

FIG. 6 shows the top view of the durable IV organizer and locking device 10 being in a fully closed and latched position by the latching member 18 as shown. This top view shows a plurality of color-coded identification markers 22 positioned in a plurality of identification shallow openings 20 (not shown in this Figure, but will be discussed in greater details later) on the top surface 11a to aid healthcare professionals in identifying the proper IVs, catheters, and any other fluid lines 14 coming from fluid sources to a patient. Note that the identification markers 22 are positioned directly above the IVs, catheters, and any other fluid lines 14 without any interference. The identification markers make it helpful to the healthcare professional to easily trace and properly align the fluid lines to the proper fluid sources. Also, when critical medical conditions exist, this will definitely help the healthcare professionals to make the proper decision for a patient, in the event that medical dosages need to be changed quickly. This could be a matter of life or death.

FIG. 7 shows an isometric cut-out-sectional view of the durable IV organizer and cover locking device 10 with multiple identification marker openings 20 being disposed in the flat and smooth top surface 11a that receive the identification markers 22 therein and establishing snug-tight frictional or wedge fit to maintain the markers stationary. Preferably, at least a pair of equally spaced marker openings 20 is disposed in the top surface 11a to easily spot or identify the fluid lines 14 at opposite ends of the durable IV organizer and cover locking device 10 to easily locate the fluid source and the proper fluid line to the patient. Preferably, the shallow openings 20 extend a specified distance above and in alignment with the plurality of elongated recessed channels 16 so that the multiple marker openings 20 are positioned to receive multiple color-coded markers 22.

Referring further to FIG. 7, the snap-action latching member 18 takes on a flexible and durable latching member that includes a C-shaped or a U-shaped latching member extending from the peripheral edge extended from the front surface 17 of the cover section 11 opposite the hinged rear surface 11c (not shown) and a projecting tongue member 19 extending from the top front surface 12a of the support base section 12 to be received within a latching recess 21 of the C-shaped or U-shaped latching member 18. Due to the flexibility of the as the C-shaped or the U-shaped latching member 18 it has the ability to be flexed over the projecting tongue member 19, so that the projecting tongue member 19 is locked into the latching recess 21. Note that the snap-action latching can be substituted by various other mechanical types of latching or locking means that would be obvious to one of ordinary skill in the art, at the time the invention was made, if desired.

FIG. 8 shows an exploded view of the identification marker 22. The identification marker 22 includes a top flat section 22a, a side section 22b and a triangle or tapered projection section 22c. The top section 22a and the side section 22b can accommodate selected colors as markers or indicia or letter markings in combination with the selected color, if desired. Also, the triangle or tapered projection 22 is inserted into the shallow openings 20 that have a selected or desired depth that does penetrate into the plurality of elongated recessed channels due to the specified thickness of the cover section 11 with a tight frictional or wedge-like fit. Note that this depth does not permit the identification markers 22 to interfere with the aforementioned fluid line conduits 14.

The identification markers 22 are able to be easily moved from one location to another so that multiple IV lines, catheters or the fluid-like tines 14 can be easily moved about and changed from one elongated recessed channel to another, if desired. This easy changeability could be a direct result of moving medical fluid sources around, so that the multiple IV lines, catheters or the fluid-like lines 14 are never entangled or overlapped with one another. Also, this changeability could be a direct result of the length of the multiple IV lines, catheters or the fluid-like lines 14 in relationship to a patient and/or the medical fluid sources. Another reason for changeability could be a direct result of changing the color codes that represents the multiple IV lines, catheters or the fluid-like lines 14 within the multiple elongated recessed channels 16.

Note that the selected color-coded indicia or marking can take on various types of structural shapes and designs that are obvious to one of ordinary skill in the art, at the time the invention was made. Note that the shallow opening 20 can be of any desired size, length and shape. Such shallow opening 20 could extend substantially the entire length of the elongated recesses 16 to receive a single identification marker 22 that is substantially the same length of the shallow opening 20, if desired.

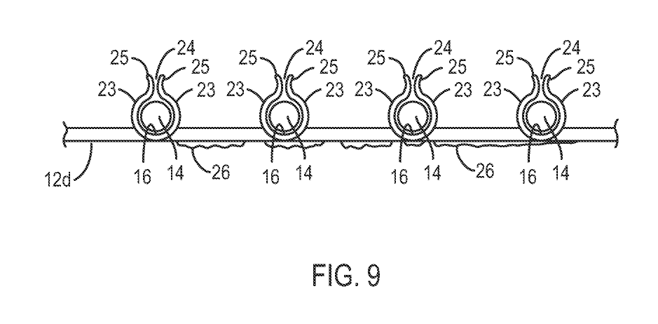

FIG. 9 shows a cutaway side view of the support base section with at least a pair of integral flexible and rigid retaining clips 23-25 and attachment securing means 26 located on a bottom surface 12d of the durable IV organizer and cover locking device 10 or solely along a bottom surface of the elongated recessed channels 16, if desired. The at least a pair of retaining clips 23-25 includes at least a pair of upstanding flexible and rigid retaining clip arm members 23. Each clip 23-25 is spaced substantially equidistantly along opposing side edges of the plurality of elongated recessed channels 116. The opposing pairs of retaining clips 23-25 have a left upward extending arm member 23 and a right upward extending arm member 23 that provide a substantial U-shaped securing passage that defines an opening 24 that is slightly smaller than the diameter of the multiple IV lines, catheters or the fluid-like lines 14 to be easily inserted into the multiple elongated recessed channels 16. Each of the upper ends of the left and right upward extending arm members 23 include an outwardly slanted extension that forms a slide-like ramp member 25 that creates a larger portion of the opening 24 that allows the multiple IV lines, catheters or the fluid-like lines 14 to slide easily along the slide-like ramp member 25 into the opening 24 and into the plurality of elongated recessed channels 16. This sliding action allows the multiple IV lines, catheters or the like fluid lines 14 to easily expand the left and right arm member members 23 further outward to increase the opening 24 to a wider position to permit the fluid lines 14 to be easily inserted there through into the plurality of elongated recessed channels 16 without deformation thereto. The retention of the multiple IV lines, catheters or the fluid-like lines 14 within the plurality of elongated recessed channels 16 occurs when the left and right arm members 23 retract back inward to decrease the opening 24 to a diameter that is smaller than the multiple IV lines, catheters or the like fluid lines 14.

If desired, the left and right arm member members 23 may have spring material or spring elements embedded within the left and right arm member members 23 to enhance its flexibility during the injection molding process.

Even though a pair of upstanding flexible and rigid retaining clips have been recited above, it is obvious to one of ordinary skill in the art, at the time invention was made, to utilize any number of retaining clips along the multiple elongated recessed channels, if desired.

Also, it would be obvious to one of ordinary skill in the art, at the time the invention was made to construct the elongated recessed channels 16 to have different selected diameters in order to accommodate different selected size IV lines, catheters or the like fluid lines 14, if desired.

Further in view of FIG. 9, the attachment means 26 on the bottom surface 12d illustrates a hook-and-loop type fabric or Velcro type fastening means that is adhesively secured thereto and removably attached to a mating a hook-and-loop type fabric or Velcro type fastening means of desired support retaining structures. Also, the attachment means 26 can take on various other types of mechanical fastening means, such as, a durable double-sided adhesive strip, snap type fasteners, a slide and lock fastening structure with adhesive backing, hooks, and straps, to name just a few.

In operation, the durable IV organizer and cover locking device 10 can be easily operated by any user and not necessarily a healthcare professional user that the present invention largely refers to. To begin operation, the durable IV organizer and cover locking device 10 is moved to a fully open position as shown in FIG. 5. Then the selected multiple IV lines, catheters or the fluid lines 14 are placed in the plurality of elongated recessed channels 16 of the support base section 12 by the healthcare professional user. Once the selected multiple IV lines, catheters or the like fluid lines 14 have been placed in the plurality of elongated recessed channels 16, then the cover section 11 is moved about hinge member 13 to a fully closed position as shown in FIG. 4.

During movement to the fully closed position, the C-shaped or the shaped latching member 18 of the cover section 11, due to its flexibility is flexed and moved over the projecting tongue member 19, so that the projecting tongue member 19 is locked into the latching recess 21 of the C-shaped or the U-shaped latching member 18. After the durable IV organizer and cover locking device 10 has been fully closed and latched, the multiple IV lines, catheters or the like fluid lines 14 are retained within and between the plurality of elongated recessed channels 15 of the cover section 11 and the elongated channels 16 of the support base section 12 without deformation and damage thereto.

In view of FIG. 9, the operation is the same as discussed above with the exception of having retaining clips 23-25 with at least a pair of left and right arm members 23 with an opening 24 and a slide-like ramp member 25 that extends outward from the opening 24 as described above. However, during placement of the multiple IV lines, catheters or the like fluid lines 14 within the plurality of elongated recessed channels 16 is the same as described in FIGS. 4 and 5 except for the following different operational feature, which will now be described.

When a healthcare professional user moves the multiple IV lines, catheters or the like fluid lines 14 along the slide-like ramp member 25, this causes the left and right arm member members 23 to expand more outwardly and increasing the diameter of opening 24 that allows the multiple IV lines, catheters or the like fluid lines 14 to slide easily along the slide-like ramp member 25 through the now larger opening 24 and into the plurality of elongated recessed channels 16. The aforementioned sliding action allows the multiple IV lines, catheters or the like fluid lines to be easily inserted into the plurality of elongated recessed channels 16 without any deformation thereto. Therefore, the retention of the multiple IV lines, catheters or the like fluid lines 14 within the plurality of elongated recessed channels 16 occurs when the left and right arm members 23 retract back inward to decrease the opening 24 to a diameter that is smaller than the multiple IV lines, catheters or the like fluid lines 14. Note that the above described retaining clips 23-25 are of a selected dimension that will be slightly larger than the multiple IV lines, catheters or the like fluid lines 14 that will fit nicely within the plurality of elongated recessed channels 15 without noticeable deformation thereto, which is due to the thickness of the cover section 11 (see FIG. 7).

The final step of operation is to place the identification markers 22 within the plurality of identification shallow openings 20 in the top cover section 11 in alignment with the elongated recessed channels 15 thereof. The triangle or tapered projection 22 is inserted into the shallow openings 20 that have a selected or desired depth that does penetrate into the plurality of elongated recessed channels due to the specified thickness of the cover section 11 with a tight frictional or wedge-like fit. Note that this depth does not permit the identification markers 22 to interfere with the aforementioned fluid line conduits 14.

These markers 22 will aid the healthcare professional user in labeling and identifying the proper multiple IV lines, catheters or the like fluid lines 14 with the proper fluid, medication or blood sources. In addition, the plurality of markers 22 will fit over and completely off the shallow openings 20 in a nice and colorful esthetic fashion. It is to be noted that the top section 22a and the side section 22b can be substantially flat and flush with the smooth and flat top section 11a. Preferably, the top section 22a and the side section 22b may be color-coded and be of selected dimensions so that indicia and lettering markings may be placed thereon to further label and identify the multiple IV lines, catheters or the like fluid lines 14. Also, the plurality markers can be easily interchanged and moved about as previously discussed in greater details above.

The embodiments in FIGS. 4-9 discloses a durable polymeric IV organizer and cover locking device for identifying, aligning and securing multiple IV lines, catheters or fluid-like lines therein to prevent damage, deformation and entanglement thereto. The IV organizer and cover locking device has a flat cover section with a plurality of elongated semi-circular channels on an under surface and a support base with a plurality of elongated semi-circular channels on a top surface for retaining the multiple IV lines, catheters or fluid-like lines therein. Each of the flat cover section and the support base section having a rear edge that forms an integral hinge section that allows the cover and the support sections to move between fully closed and open positions as a one-piece unitary device. A flexible C-shaped latching means with a receiving opening extending from a front peripheral edge of the cover section and a projecting tongue latching means extending from a front peripheral edge of the support section. The C-shaped latching means is flexed over the tongue latching means until the tongue latching means is received within the receiving opening to latch the IV organizer and cover locking device in the fully closed position. The cover section has a plurality of identification shallow openings for receiving removable identification markers for aligning, identifying and interchanging the multiple IV lines, catheters or fluid-like lines. Flexible retaining clips disposed in the elongated channels of the support section.

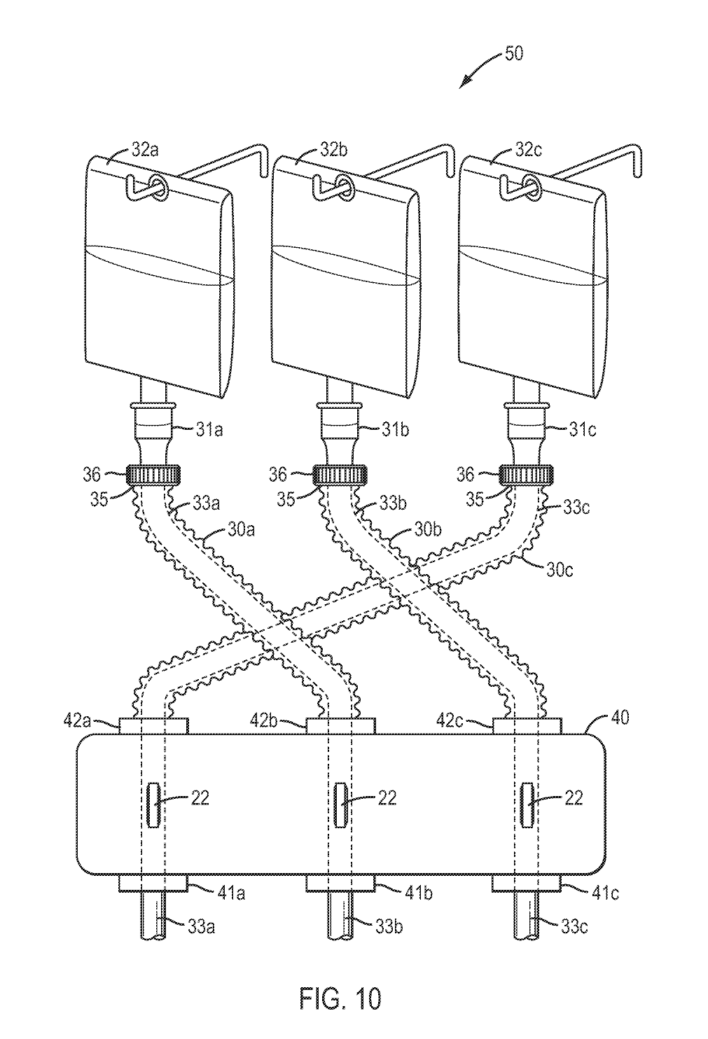

FIGS. 10-16 illustrate that an alternate embodiment of the IV organizer system 50 (FIG. 10) may include a plurality of retractable color-coded sleeves 30a, 30b, 30c that extend from an IV organizer 40 and connect to a plurality of drip chambers 31a, 31b, 31c of IV bags 32a, 32b, 32c. The system 50, shown in FIG. 10 including an IV organizer 40 attached to multiple color-coded sleeves, enables health professionals to quickly differentiate multiple IV lines and manage the administration of the medications. Several color-coded features are provided in this embodiment to enable the health professional to quickly and easily di scent each fluid line. The retractable color-coded sleeves 30a, 30b, 30c provides a mechanism to clearly differentiate each IV fluid line as they extend from the IV bags 32a, 32b, 32c through an IV organizer 40 to the point of insertion in a person's body (not shown). In addition to the color-coded sleeve 30, corresponding color collars or caps cart be placed at the ingress and egress of the IV organizer 40 to quickly and easily identify specific fluid tubing. The present invention provides a color-coding scheme that clearly delineates the fluid lines without mixing a solution with the medical fluid within the IV bag 32, as commonly used in some conventional devices. The present invention also provides a compact, transportable, reusable device that can be quickly and conveniently attached to existing fluid lines and provide a fluid line management system.

In FIG. 10, a plurality of IV fluids has a flow path that flows from IV bags 32a, 32b, 32c pass the tubes of the drip chambers 31a, 31b, 31c and enters the fluid lines 33a, 33b, 33c, which connect via outlets 34a, 34b, 34c to an IV organizer 40. The fluid lines 33a, 33b, 33c transport the IV fluid from the IV bags 32a, 32b, 32c through the IV organizer 40 to the patient (not shown). The IV organizer 40 can be basically configured according to include one or more of the features described above. The color-coded sleeves 30a, 30b, 30c aid health professionals by reducing the risk of medical mistakes and medication errors by clearly distinguishing each IV line and allowing the sleeves to be seen in the dark. During medical treatment, it is a common practice for a patient to receive multiple medications delivered at multiple insertion sites via multiple IV lines.

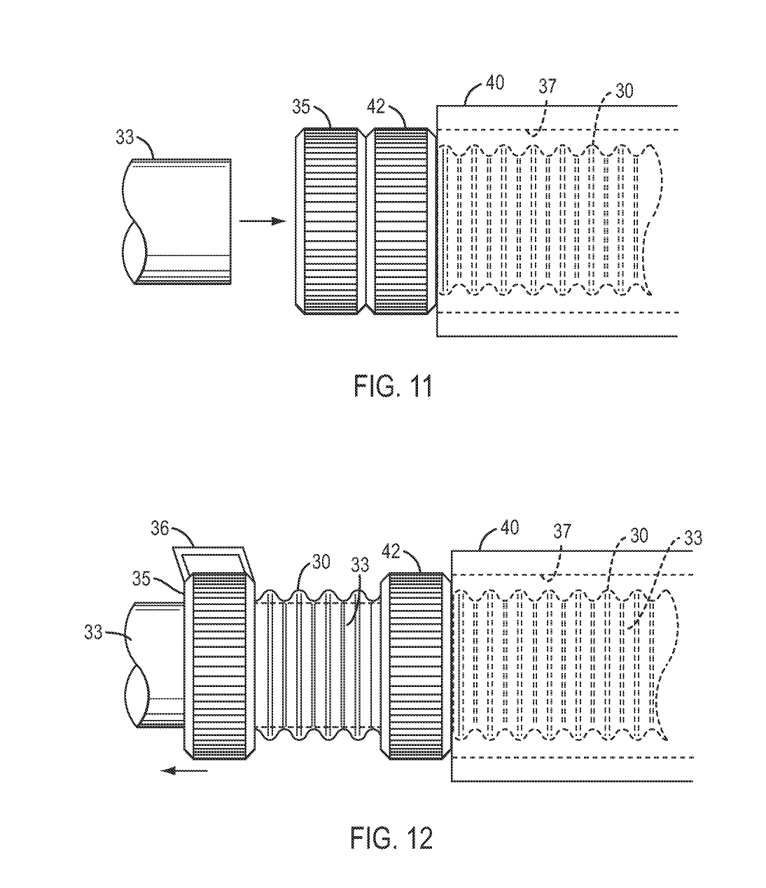

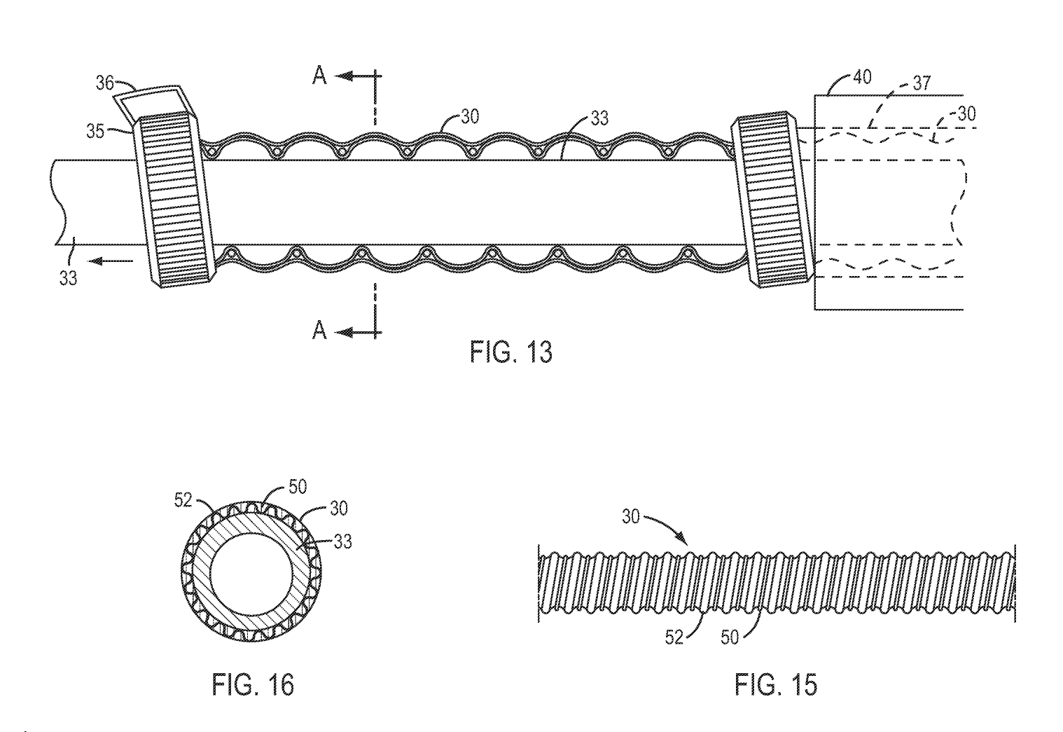

As shown in FIGS. 11-13, the sleeve 30 forms an extendible and retractable tube or hose including a thin-walled corrugated tube of a soft flexible material. The sleeve 30 includes a generally tubular body which is formed of plastic rubber or other suitable material so as to be contiguous and otherwise to enclose, direct and guide the movement of the fluid line 33 passing through the sleeve (FIGS. 12-13). FIG. 11 shows the sleeve 30 in a retracted position within the IV organizer before insertion of the fluid line 33. FIG. 12 shows the sleeve 30 in a slightly extended position surrounding the fluid line 33 after insertion. FIG. 7 shows the sleeve 30 in a further extended positioned surrounding the fluid line 33. The retractable tubing is provided to offer a more sturdy and rigid structure to the sleeve. The retractable color-coded sleeves 30 may include a stretchy, flexible material 50 similar to a stockinet or glove that retains its shape and fits snugly around the tubing so that it completely surrounds and contacts the coil of the tubing to form corrugations in the stockinet, as shown in FIG. 15, FIG. 15 illustrates that the stretchable material 50 can be made in connection with the tubing 52 during the manufacturing process of the sleeve 30. During use, the sleeve is capable of being stretched from the IV organizer 40 such that it substantially covers the length of the IV fluid lines 33a, 33b, 33c to the drip chamber 31. In various embodiments, the sleeve 30 can be stretched to have an extended length, for example, between 25 inches to 100 inches and have a diameter that will accommodate various standard IV fluid lines. The stretchable material 50 and tubing 52 of the retractable color-coded sleeve 30 slides over to fit snugly around and conform to the shape of the IV fluid line prevent any drooping, as shown in the sectional view in FIG. 16. After it is disconnected from the drip chamber and the pulling force is released, the sleeve 30 is capable of returning to its original shape and length in its retracted position within the IV organizer 40, as shown in FIG. 11. The stretchable material 50 may be made with any photoluminescent fibers that glow-in-the-dark to allow the sleeves covering the IV lines to be seen in the dark to further prevent medical mistakes. The active material in the sleeves may include Strontium Aluminate which glows in dark environments when charged. Any light source, such as bright sunlight, UV light, normal office or home lighting, will charge the photoluminescent fibers. Bright sunlight or UV light wilt charge the photoluminescent fibers in the sleeves fastest. By exposing the sleeve to a light source, the sleeves can be continuously recharged over and over without any diminishment in the glow quality. Furthermore, the sleeves do not require a power source, such as a battery, which is typically employed in glow emitting devices, such as luminators, i.e., a LED or a light bulb.

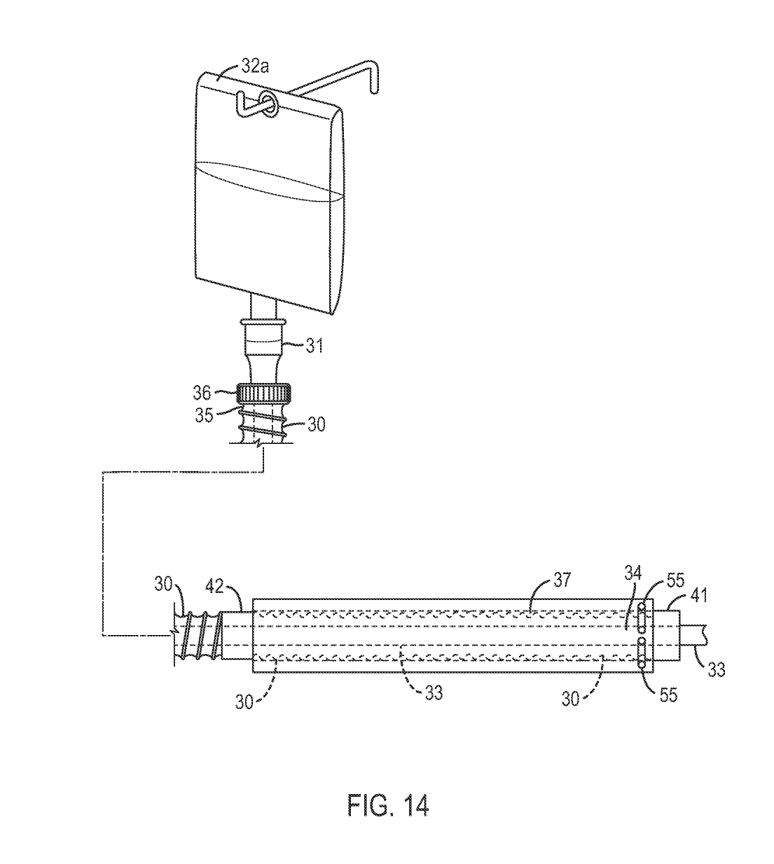

Each retractable color-coded sleeve 30 may be releasably attached to or configured as an integral part of the IV organizer 40 via connectors 34a, 34b, 34c (FIGS. 13 and 14). In the preferred embodiment, as shown in FIGS. 10-14, the sleeve 30a, 30b, 30c is attached to the IV organizer 40 as an integral component thereof to provide a compact, reusable, and unitary device for quick and efficient use by a health professional. In FIGS. 11-14, the IV organizer 40 includes a hollow cavity 37 which forms a channel for accommodating the sleeve 30 in which the sleeve 30 can be retracted therefrom and stored within when not in use (FIG. 11), similar to a vacuum cleaner hose or a hair dryer hose. FIG. 14 illustrates an exemplary embodiment of connecting one color-coded sleeve to one IV bag. As shown in FIG. 14, a first end 34 of the sleeve 30 connects within the IV organizer 40 to the side walls of the cavity 37 via a fastening means 55. A second connector end 35 of the sleeve 30 can be connected by an attachment mechanism 36 to a drip chamber 31. The attachment mechanism 36 may include a reinforced elastically expanding end of the sleeve or a clamp, clip, or any other fitting. Instead of connecting directly to the drip chamber as shown in FIG. 10, the second connector end 35a can be connected along a substantial portion of the fluid line 33 so long as the health professional can easily discern each fluid line 33.

As shown in FIGS. 10 and 14, in various embodiments, at the outlet where the IV fluid lines 33 exits the IV organizer 40, one or more external color-coded collars 41a, 41b, 41c may be connected to the IV organizer 40. Each collar 41 may be color-coded to correspond to the color of the respective color-coded sleeve 30 extending through each cavity 37. The collars 41 can be configured as an integral component of the IV organizer 40 or can be removably attached to the IV organizer 40 by way of a screw, clamp or a snap-fit arrangement. In FIGS. 11-14, at an opposite end of the IV organizer, an outlet 42a, 42b, 42c may be integrally connected to the IV organizer 40. Similar to the collars 41, the outlets 42 may also be configured having a color scheme that corresponds to each respective sleeve. The diameter of the external collars 41a, 41b, 41c and the outlets 42a, 42b, 42c are configured to receive and accommodate various sizes of standard fluid lines 30 entering and extending through the IV organizer 40.

In FIG. 11, in the stored position and when not in use, the sleeve 30 is corrugated such that it can be stored within the IV organizer 40. When in the stored position, the sleeve 30 retracts within the cavity 37 of the IV organizer such that connector end 35 abuts the outlet 42. In various embodiments, an attachment mechanism (not shown), such as a snap-fit, screw or hook and loop attachment means, may be provided to connect connector end 35 to outlet 42 to provide compact storage of the device. During use, as shown in FIG. 11, the health professional initially inserts the fluid tubing 33 into the IV organizer 40 passing through the connector end 35 and the outlet 42 such that the retracted sleeve 30 readily fits over the fluid tubing 33 (FIG. 16). During the insertion process, the fluid tubing 33 is inserted completely through the IV organizer 40 and extends outwardly of collar 41 (FIGS. 10 and 14). In the sectional view of FIG. 16, the sleeve 30 can be seen having the fluid tubing 33 inserted thereinside. After the fluid tubing 33 is inserted through the collar 41 of the IV organizer 40, the health professional can then grip the connector end 35 (FIGS. 12-13) and pull the sleeve 30 from within the IV organizer 30 such that it stretches over the fluid tubing 33 and attaches to the drip chamber 31, as shown in FIG. 10. FIG. 12 shows the sleeve 30 slightly extended from the IV organizer 40 during the attachment process, and FIG. 13 shows the sleeve 30 further extended from the IV organizer 40.

As mentioned above, when in use and attached to the drip chambers, as shown in FIG. 10, or substantially along the fluid lines (FIG. 13), the system 50 provides several color-coded features to enable a health professional to quickly and easily discern each fluid line. The retractable color-coded sleeves 30a, 30b, 30c provides a mechanism to clearly differentiate each IV line from the flow path at the IV bags 32a, 32b, 32c through an IV organizer 40 to the point of insertion in a person's body. In some embodiments, the sleeve 30 may be comprised of a photoluminescent material, such as Strontium Aluminate, that glows in the dark without requiring the use of a power source. In addition to the color-coded sleeves, the color-coded collars 41a, 41b, 41c and outlets 42a, 42b, 42c further differentiate the fluid line as they enter and exit the IV organizer 40 and to the multiple points of insertion in the patient.

It is to be further noted that other industrial and environments of use can utilize the IV organizer and locking device 10, 40 to accommodate other types of multiple wiring, cables and fluid tines, pipes or conduits to prevent them from overlapping, entanglement and confusion in tracing them to a source and to a user. Also, the IV organizer and locking device 10, 40 will aid users in easily labeling and identifying of multiple wiring, cables and fluid lines, pipes or conduits.

While the foregoing written description of the invention enables one of ordinary skill in the art to make and use what is considered presently to be the best mode thereof, those of ordinary skill will understand and appreciate the existence of variations, combinations, and equivalents of the specific embodiment, method, and examples herein. The invention should therefore not be limited by the above described embodiment method, and examples, but by all embodiments and methods within the scope and spirit of the invention as claimed.

What is claimed is:

1. A device for identifying, aligning, and securing a plurality of cables, the device comprising:
a cover section provided with a plurality of recessed channels on an under surface;
a support base section provided with the plurality of recessed channels on a top surface for retaining a plurality of cables;
a hinge section interdisposed between the flat cover section and the support base section to enable the cover section and the support base section to move between a closed position and an open position;
a latching mechanism configured to latch the cover section and the support base section in the closed position;
at least one removable identification marker removably insertable in at least one opening provided in the cover section for identifying each one of the plurality of cables; and
at least one pair of retaining clips disposed along the elongated channels of the support base to retain each one of the plurality of cables.

2. The device of claim 1, wherein the latching mechanism comprises at least one of a tab, a rib, a C-shaped latching mechanism, a U-shaped latching mechanism, and a projecting tongue member.

3. The device of claim 1, wherein the at least one removable identification marker comprises a color-coded indicia to identify a least one of the plurality of cables.

4. The device of claim 1, wherein the at least one opening extends parallel to and in alignment with the plurality of recessed channels.

5. The device of claim 5, wherein the at least one removable identification marker is configured having a tapered section to enable the at least one removable identification market to be frictionally inserted into the at least one opening.

6. The device of claim 1, wherein the latching mechanism comprises a receiving opening extending from a front peripheral edge of the cover section and a projecting tongue latching mechanism extending from a front peripheral edge of the support base section such that the latching mechanism is capable of extending over the tongue latching mechanism and being received within the receiving opening to latch the cover section and the support base section in the closed position;

7. The device of claim 1, wherein the at least one pair of retaining clips are space equidistantly along opposing side edges of the plurality of recessed channels.

8. The device of claim 7, wherein the at least one pair of retaining clips comprises a left upward extending arm member and a right upward extending member that defines a substantially U-shape securing passage for retaining the plurality of cables.

9. The device of claim 1, wherein the plurality of cables comprises at least one of an intravenous line, a catheter, a fluid conduit, a telecommunication cable, a computer wiring, and an electrical wiring.

10. The device of claim 1, wherein the at least one pair of retaining clips are capable of adjusting to accommodate and retain the plurality of cables having differing configurations.

11. A system for identifying, aligning, and securing a plurality of cables, the system comprising:
a multiple line organizer configured having a plurality of cavities, a plurality of inlets and a plurality of outlets for extending a plurality of cables therethrough; and
a plurality of retractable sleeves capable of being stored within the plurality of cavities, capable of being extended from the multiple line organizer, capable of receiving the plurality of cables extending through the multiple line organizer therein and capable of being retracted within the multiple line organizer.

12. The system of claim 11, wherein the plurality of retractable sleeves comprises a plurality of color-coded sleeves to differentiate each plurality of cables when extended from the multiple line organizer.

13. The system of claim 12, wherein the plurality of retractable sleeves includes a flexible material that completely surrounds the plurality of retractable sleeves in a snug fit to form a plurality of corrugated stockinets.

14. The system of claim 13, wherein the plurality of stockinet is capable of being extended from the multiple line organizer to cover an entire length of each plurality of cables when a pulling force is applied and after the pulling force is released, the plurality of stockinet is capable of being retracted to an original corrugated shape within the multiple line organizer.

15. The system of claim 12, wherein the plurality of retractable sleeves comprises a photoluminescent fiber that glows in a dark environment.

16. The system of claim 15, wherein the photoluminescent fibers comprises Strontium Aluminate which glows in the dark environment when charged.

17. The system of claim 16, wherein the Strontium Aluminate is capable of being repeatedly charged when exposed to a light source and without requiring a power source.
